(19) United States
(12) Patent Application Publication
(10) Pub. No.: US 2026/0093962 A1
(43) Pub. Date: Apr. 2, 2026

(54) CONSISTENCY MODEL WITH DENOISING ERROR

(71) Applicant: THE TORONTO-DOMINION BANK, TORONTO (CA)

(72) Inventors: Noel Vouitsis, Markham (CA); Rasa Hosseinzadeh, TORONTO (CA); Brendan Leigh Ross, TORONTO (CA); Victor Valentin Villecroze, TORONTO (CA); Satya Krishna Gorti, TORONTO (CA); Jesse Cole Cresswell, TORONTO (CA); Gabriel Loaiza Ganem, TORONTO (CA); Maksims Volkovs, TORONTO (CA)

(21) Appl. No.: 19/347,043

(22) Filed: Oct. 1, 2025

Related U.S. Application Data
(60) Provisional application No. 63/702,399, filed on Oct. 2, 2024.

(51) Int. Cl. G06N 3/0475; G06F 17/13

(52) U.S. Cl. CPC G06N 3/0475; G06F 17/13

(57) ABSTRACT

A consistency model is trained to mimic the output of a diffusion model at various points along the denoising trajectory. A trajectory of the diffusion model is determined by generating the data point with the diffusion model by sampling a noised data point and applying denoising steps of the diffusion model to obtain the denoised output. At each of the noise levels, the consistency model is applied to the corresponding data point to remove the remaining noise. The resulting data point from the consistency model is compared with the denoised output of the diffusion model. An error for the consistency model may then be determined based on the comparisons at the various points in the trajectory.

### CROSS-REFERENCE TO RELATED APPLICATION

This application claims the benefit of U.S. Provisional Application No. 63/702,399, filed on Oct. 2, 2024, the contents of which is hereby incorporated by reference in its entirety.

### BACKGROUND

This disclosure relates generally to distilling diffusion models and more particularly to training a consistency model from a diffusion model.

Diffusion models are generative models that learn to reverse a noising process that iteratively transforms data into noise. The “complete noise” output by the noising process may be modeled as a probability distribution, such that new samples can be generated by sampling from the probability distribution and iteratively applying the diffusion model to “denoise” the sample. Diffusion models typically characterize the denoising process as an ordinary differential equation (ODE), often as a probability flow (PF) ODE. Although the resulting samples (e.g., images) from diffusion models are often highly realistic, because of the iterative sampling process (ideally, modeled as a continuous function), the generation process may be computationally intensive as each iterative step calls the underlying generative network.

One approach for reducing the computational requirements while maintaining adequate sample quality is to learn a “consistency model” that aims to simulate the diffusion model results in fewer steps. As discussed below, typically, consistency models do so by maintaining an iterative training process, such that the consistency model uses a loss that measures and aims to minimize a loss between sequential steps of the consistency model using a consistency distillation loss. That is, consistency models are not trained to directly optimize for “solving” the diffusion model; instead, they learn with a self-consistency approach, such that nearby steps of a diffusion trajectory are encouraged to evaluate to the same output by the consistency model. While this approach in some instances generates effective data samples, these consistency models may still generate data samples that significantly differ from the outputs of a diffusion model.

### SUMMARY

To improve consistency model correspondence with diffusion model generation, the consistency model is trained to directly learn the generated output of the diffusion model at each point along the trajectory of a diffusion model. To obtain data for the consistency model to learn, a trajectory of “noised” data points is determined from the diffusion model generation process as it iteratively “denoises” a sampled value to obtain a diffusion data point. To more directly model the diffusion model process, the consistency model evaluates each data point in the trajectory of noised data points (excluding the final “denoised” output) to generate corresponding denoised data points as generated by the consistency model. As such, the denoised data points represent an output of the consistency model when applied in a single step to obtain output data points in the data domain.

Rather than compare the denoised data points with one another to encourage sequential similarity in the consistency model, the denoised data points are evaluated with respect to the diffusion data point output by the diffusion model. The distance between each denoised data point and the diffusion data point is measured to determine a consistency error that directly quantifies the difference in output from the diffusion model compared to the denoised output from the consistency model. This consistency error may then be used to train parameters of the consistency model and to reduce this difference, enabling more similar reproduction of data samples consistent with the diffusion model with this “strong” supervision of the diffusion model.

### BRIEF DESCRIPTION OF THE DRAWINGS

FIG. 1 illustrates an example generative modeling system, according to one embodiment.

FIG. 2 show examples of a diffusion model, according to one or more embodiments.

FIG. 3A shows an example trajectory of a sampled data point, according to one or more embodiments.

FIGS. 3B-C shows example loss functions for a consistency model, according to one or more embodiments.

FIG. 4 shows an example dataflow for calculating a consistency error for training a consistency model, according to one or more embodiments.

FIG. 5 shows an example process for training a consistency model, according to one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

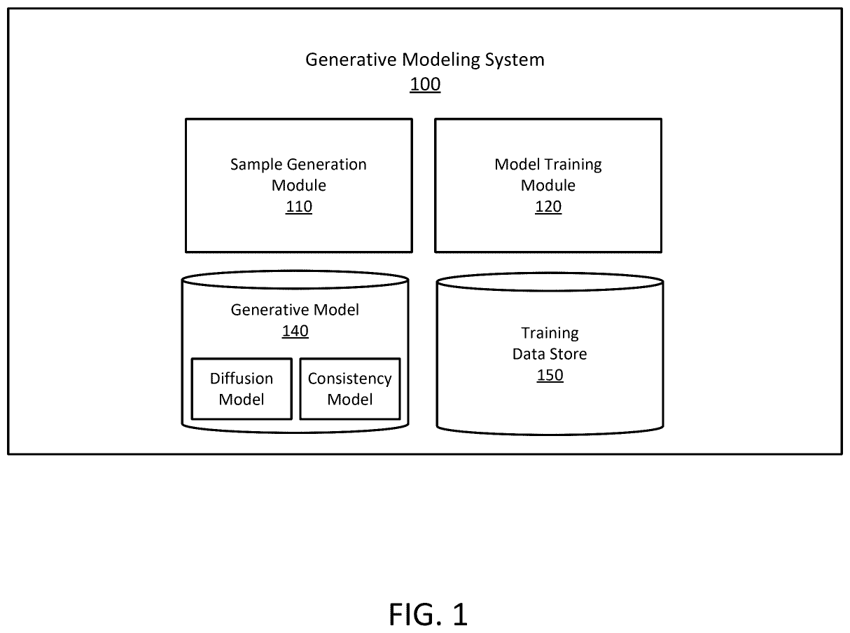

FIG. 1 illustrates an example generative modeling system 100, according to one embodiment. The generative modeling system 100 trains and applies one or more generative models 140 that may create new data samples based on learned parameters. The generative models 140 may include a diffusion model that may include iterative modeling of a denoising process. In particular, the diffusion model may aim to model denoising of a sampled value as a continuous process that may be modeled as an ordinary differential equation (ODE). In addition, a consistency model may also be trained (and sampled from) that distills the diffusion model for effective application with a more limited number of iterations (e.g., iterative steps) such 4, 2, or a single iteration. Although, for convenience, the model training and model application (i.e., new data sample generation) are discussed herein as performed by the generative modeling system 100; in practice, one system (or set of systems) may train the generative model(s) 140, and another set of systems may apply the generative model(s) 140 to generate new data samples.

In general, the generative model 140 has a diffusion model with parameters trained on a set of training data samples. In general, a set of training data samples, which may be stored in a training data store 150, may be used to train the diffusion model. The particular type of training data differs across different embodiments and may include images, video, text, tabular data, and other types of data. The training data generally may include hundreds, thousands, millions, or more of individual data samples for use by a computer model. Each data sample may include a number of features/values that vary across a number of dimensions and may be organized as an array, matrix, or other high-dimensional structure. For example, a multi-color image is generally composed of a matrix comprising dimensions corresponding to the height and width of the image and a number of color channels, such that an individual pixel (i.e., a position) in the image is described by a particular height, width, and color value for each color channel. Each data sample may also include a number of labels or other additional information used for training the generative model 140. Images are generally used in this disclosure as an example of a type of data sample that may be used; additional types of data samples with additional characteristics may be used in other embodiments.

This natural data is often observed, captured, or otherwise represented in a “high-dimensional” space of n dimensions ( [symbol] ⁿ). While the data may be represented in this high-dimensional space, data of interest typically exists on a manifold [symbol] having lower dimensionality [symbol] ^{m} than the high-dimensional space (n>m). The manifold dimensionality may also be referred to herein as a dimensionality of a latent space that may be mapped to the manifold or as the “intrinsic” dimensionality of the data set, which may differ in different regions of the data set. As such, the overall manifold learned by the model may be a “union of manifolds” representing the different manifolds in different regions of the data. In general, the data samples in the training data store 150 exist in such a “high-dimensional” space. As one example, for image data, the “high-dimensional” space in which images could exist includes all possible color values across all color channels at each pixel position across the height and width of an image. Meanwhile, the training data for particular applications typically occupies a small subset of those possible images.

During the training process, the generative model 140 implicitly attempts to learn the relevant regions of the high-dimensional space (together forming a manifold [symbol] ) and, typically, a probability distribution across it. The generative model 140 may be referred to as a “deep” generative model, as it may include a large number of model parameters and multiple layers of model parameters that may be modified during the training process to learn the relevant regions and probability distribution. The particular number of tunable parameters for the generative model 140 varies in different embodiments and may include hundreds, thousands, tens of thousands, millions, or more tunable parameters. Generative models 140 may particularly include diffusion models (DMs), which are capable of learning a low-dimensional structure that may differ across regions of the output space. In general, the generative model 140 attempts to learn the unknown probability distribution of the ground truth distribution by maximizing the likelihood of the training data. As such, the generative model 140 can include a probability distribution that can be sampled from and transformed to a point (i.e., a data sample) in the high-dimensional space.

As discussed further below, while the diffusion model is trained with respect to the training data store 150, a consistency model may be trained as a distillation of the diffusion model. Because the diffusion model may require repeated iterations (and accompanying calls to its trained parameters) to generate data samples, the consistency model attempts to learn a process for similar data generation without requiring as many iterative steps by learning a distillation of the diffusion model. Particularly, as discussed further below, the consistency model is configured with parameters that may be based on the generative process of the diffusion model. Particularly, the diffusion model may be configured to generate sequential, iterative mappings from data sample xₜ at a first noise level t to a second marginally lower noise level t′: ƒ:(xₜ, t, t′) [symbol] x_{t′}. In contrast, while the consistency model in some cases can be configured for iterative application, the consistency model is typically trained to directly obtain a denoised data point (e.g., as a model output) x₀ from a data sample xx at a particular noise level t: ƒ_{θ}(xₜ_{ₙ}, tₙ) [symbol] xₜ using consistency model parameters θ.

In various embodiments, the generative model 140 may also be trained to generate data samples in conjunction with (e.g., conditioned on) a query. The training data store 150 may include one or more queries associated with each training data sample, such that the generative model 140 learns to generate data samples based on an input query. The query may typically be a sequence of textual tokens, such as a sentence associated with and describing the data sample.

A model training module 120 trains the generative model 140 based on the set of training data samples from the training data store 150. The model training module 120 may use any suitable machine-learning techniques to train parameters of the generative model 140 based on the type and architecture of the generative model 140. Such techniques may include supervised or unsupervised training techniques, evaluation of error/loss functions, backpropagation, gradient descent, and so forth, which may vary in different embodiments and for different applications.

As discussed further below, the consistency model may be trained by the model training module 120 using denoising trajectories from the diffusion model. As the diffusion model generates a data sample, it may generate a “trajectory” as it denoises a sampled data point to obtain an output. This trajectory thus includes noised data points at different noise levels. To train the consistency model, the various noised data points are applied to the consistency model to obtain denoised versions of the noised data points (according to the parameters of the consistency model). These denoised data points may then be compared with the generated data sample of the diffusion model to determine a distance between the generated data sample and each of the denoised data points. These distances may then be combined to determine an overall loss of the diffusion model that may be used to train the model.

Samples from the generative model 140 (e.g., the diffusion or consistency model) may be generated by a sample generation module 110, for example, based on requests from additional systems. These additional systems may provide textural queries or other parameters for generating a data sample by the sample generation module 110. The particular method for generating data samples may vary in different embodiments and may include sampling from a probability distribution associated with the generative model 140 and applying parameters of the generative model 140 to obtain a generated data sample in the data space.

Although these components are shown in FIG. 1 as part of a generative modeling system 100, in additional embodiments, these components may be located at various separate systems. For example, in one embodiment, the generative model 140 is trained by one computing system, while another computing system generates new data samples based on the trained generative model 140. Similarly, individual components of the generative modeling system 100 may also be distributed across multiple computing systems. For example, the model training module 120 may be distributed across multiple training systems, such that one set of systems is configured to jointly train the generative model(s) 140, and another set of distributed systems is configured to apply the generative model 140 to create new data samples.

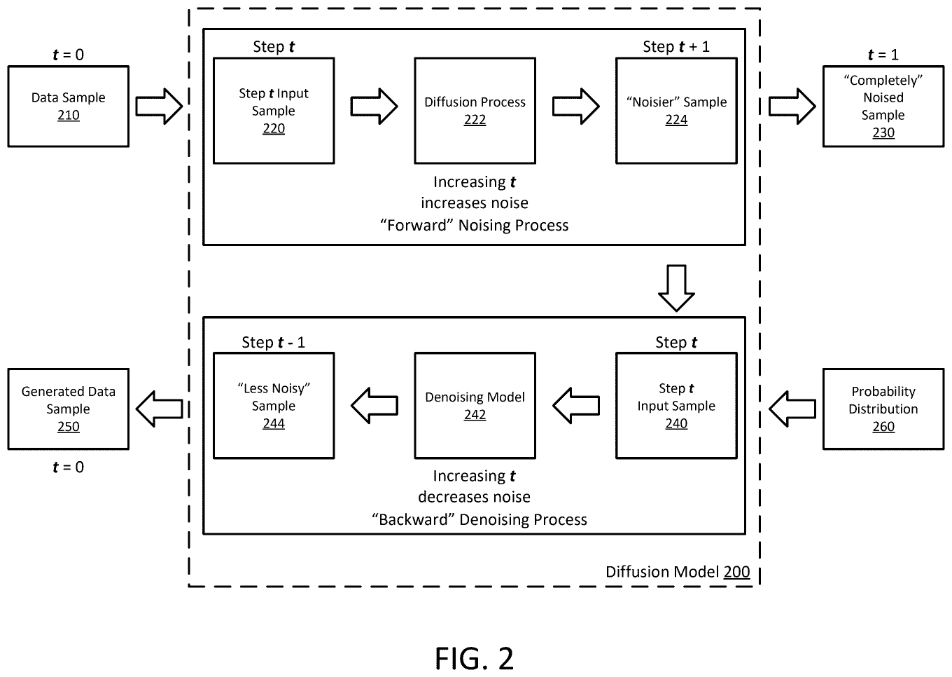

FIG. 2 show examples of a diffusion model, according to one or more embodiments.

A diffusion model 200 typically include two portions, a “forward” process that adds noise to a data sample according to a noise level, and a “backward” process that removes noise from a data sample having a specified noise level. The noise level at a particular point in the process is typically specified based on a value t selected from a range between zero and one.

As shown in the approximation of FIG. 2, a forward noising process is applied to a data sample 210 that, when applied to the full noise level at t=1, results in a completely noised sample 230. The forward noising process at each “step” of t receives a step t input sample 220 (denoted Xₜ) and applies a diffusion process 222 to generate a noisier sample 224 that becomes an input for the subsequent step. The diffusion process 222 typically applies stochastic noising (i.e., Brownian motion) to the input sample Xₜ. Though shown here as “steps,” the process is typically continuous and defined as a stochastic differential equation. Formally, diffusion models may use Equation 1 to define the differential change in a data point noise level t:

$${dX}_{t} = f ( {X}_{t} , t ) dt + g ( t ) {dW}_{t} , {X}_{0} \sim p ( \cdot , 0 ) \qquad Equation 1$$

in which:
X₀˜p (⋅, 0) is a data point sampled from the distribution of training data at t=0;
ƒ(Xₜ, t): [symbol] ^{D}×[0,1]→ [symbol] ^{D} is a hyperparameter;
g:[0,1]→ [symbol] is a hyperparameter;
Wₜ is a D-dimensional stochastic noising function (i.e., Brownian motion).

In typical diffusion models, the function ƒ(Xₜ, t) defining the contribution of Xₜ is a linear function of t:

$$f ( x , t ) = b ( t ) x . \qquad Equation 2$$

for a function b: [0,1]→ [symbol] .

Because the diffusion process adds noise at each step, individual data samples may “diffuse” probabilistically to regions of the output space as the noise level is increased until at the noise level of “1” at which the complete noise level is applied. At this noise level, the data samples probabilistically diffuse across the output space. Using data samples at different noise levels, parameters of the diffusion model 200 are trained in a denoising model 242 that learns to “denoise” the corresponding noise of noise levels of the forward noising process to denoise from noise level 1 to noise level 0. Particularly, at each “step” of the denoising process, a step t input 240 is applied to the denoising model 242 to generate a step t−1 output sample as a “less noisy” sample 244. The denoising model 242 is applied iteratively to reduce the noise level until a generated data sample 250 at noise level t=0. Like the forward noising process, the backward process (Yₜ: =X₁₋ₜ) of denoising model 242 may be modeled continuously as a stochastic differential equation:

$${dY}_{t} = [ {g}^{2} ( 1 - t ) s ( {Y}_{t} , 1 - t ) - f ( {Y}_{t} , 1 - t ) ] dt + g ( 1 - t ) d {\hat{W}}_{t} , {Y}_{0} \sim p ( \cdot , 1 ) \qquad Equation 3$$

where s(x, t) is a score function learned by parameters of the denoising model 242 (e.g., a neural network model) and aims to learn s(x, t): =∇log p(x, t) where ∇ is differentiation with respect to the data sample x;
Ŵₜ is another D-dimensional stochastic noising function (i.e., Brownian motion); and
Y₀˜ p(⋅, 1) denotes initial denoising samples Y₀ drawn from the “fully noised” distribution p(⋅, 1).

To generate new data samples with the diffusion model 200, a probability distribution 260 may be modeled as a D-dimensional Gaussian distribution. An initial data sample is drawn from the D-dimensional Gaussian distribution and Equation 3 applied from Y₀ to Y₁ to generate denoised generated data sample 250.

As the denoising process models the denoising as a continuous process, to tractably obtain samples the diffusion model may be modeled as an iterative sequence of data points.

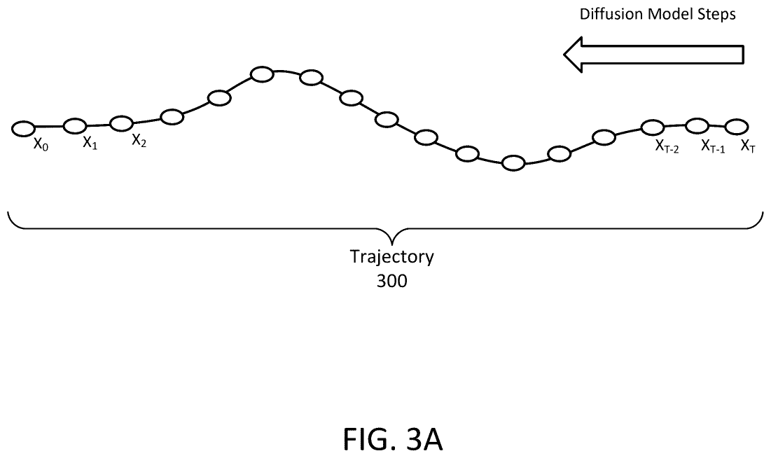

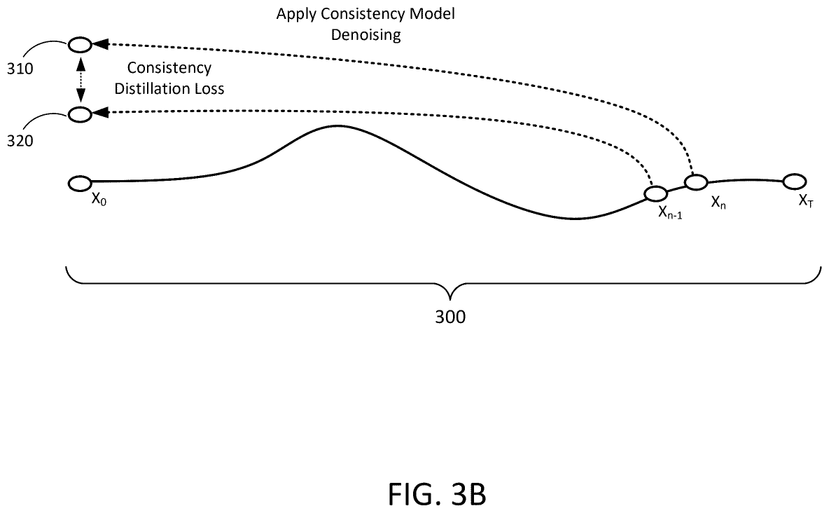

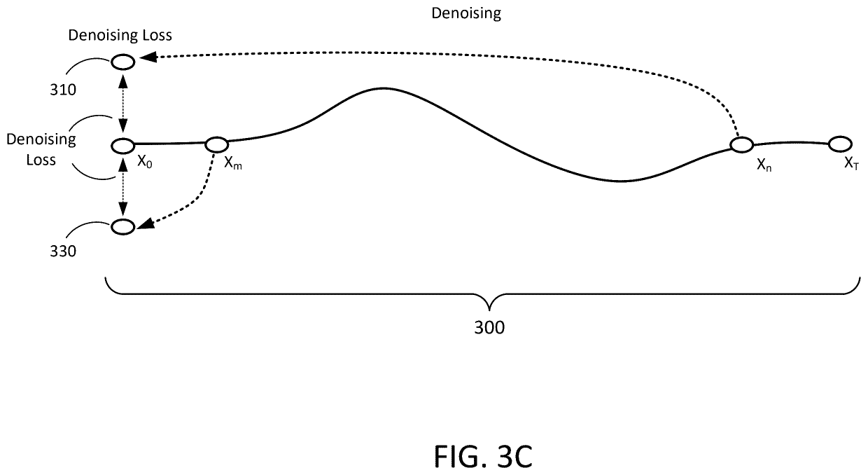

FIG. 3A shows an example trajectory 300 of a sampled data point, according to one or more embodiments. Initially, a data sample may be obtained from a probability distribution that represents a fully “noised” value at X_{T}. As the data point is denoised with iterations of the diffusion model, the data point may “move” within the data domain, represented by different positions in the “trajectory” as the data sample is denoised. As such, the iterative diffusion model steps may denoise the data point from X_{T} to X_{T-1} to X_{T-2} and so forth until the data point is fully denoised at X₀.

FIGS. 3B-C shows example loss functions for a consistency model, according to one or more embodiments. FIG. 3B shows an example consistency distillation loss function of a consistency model with a “weak” supervision of the diffusion model. In this loss function, the consistency model aims to minimize a loss between nearby (or sequential) steps of the consistency model. Rather than attempting to directly solve or optimize the output of the diffusion model, a loss is determined based on the consistency model applied to nearby points in the trajectory 300. In this example, points xₙ and xₙ₋₁ are applied to the consistency model to obtain the corresponding denoised points that represent removing all noise (e.g., at t=0). In this example, a first denoised data point 310 is obtained by applying the consistency model to xₙ and a second denoised data point 320 is obtained by applying the consistency model to xₙ₋₁.

In the consistency distillation loss of FIG. 3B, the consistency model is trained to provide similar denoised outputs relative to itself, such that the consistency model is guided by the evaluation of the consistency model applied to another nearby point rather than output x₀ determined by the diffusion model. Although the consistency model may use a loss with respect to x₀ at an initial step, it is typically applied only to prevent collapse of the consistency model during training. While the consistency distillation loss of FIG. 3B can yield effective consistency models, these models may be less effective at accurately denoising points at various points of the trajectory and tend to yield outputs with higher differences with the diffusion model output x₀.

FIG. 3C shows an example distillation loss based on denoising the trajectory towards the diffusion data sample, according to one embodiment. In this training loss, rather than guiding the consistency model towards itself, the consistency model is evaluated with respect to similarity to the diffusion output x₀. As discussed in additional detail below, the consistency model may be applied at different points of the trajectory (e.g., noised data points including at least some noise (t>0)) to determine corresponding denoised points and evaluate them with respect to the diffusion output. In the example of FIG. 3C, the first data point Xₙ is applied to the consistency model to determine a first denoised data point 310. Similarly, additional data points in the trajectory are applied to the consistency model to determine additional denoised data points. The example of FIG. 3C illustrates a second data point Xₘ applied to the consistency model to determine a second denoised data point 330. Rather than determining a loss by comparing these points to one another, a denoising loss is determined based on a distance of the denoised data points 310, 330 to the diffusion data point X₀.

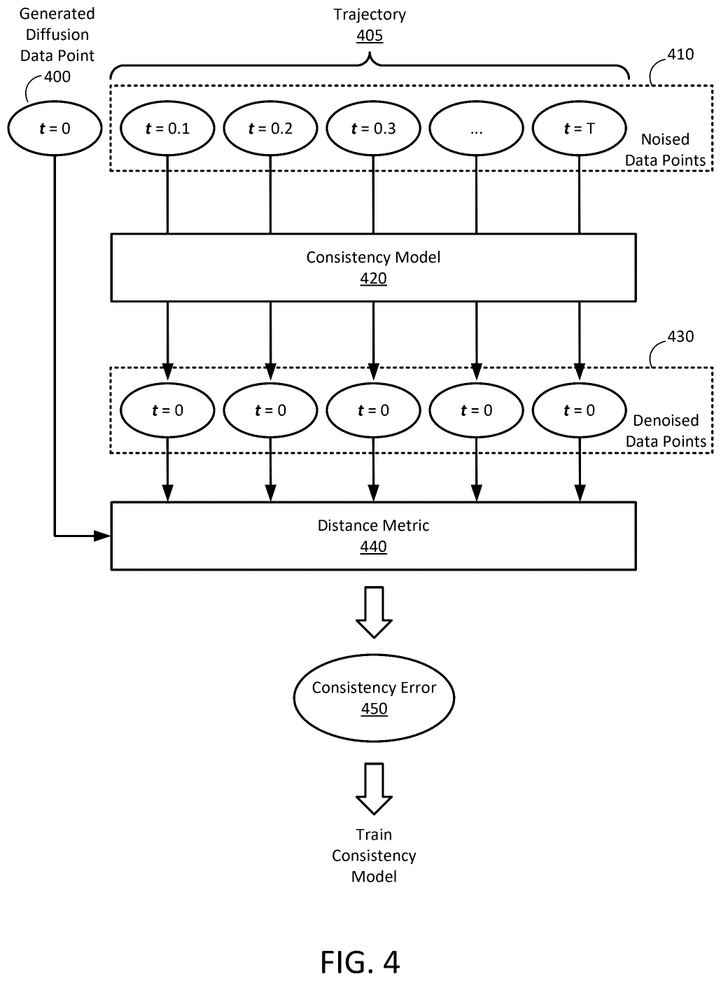

FIG. 4 shows an example dataflow for calculating a consistency error 450 for training a consistency model 420, according to one or more embodiments. This dataflow may be processed, for example, with a model training module 120 as shown in FIG. 1. Initially, the diffusion model may be used to obtain a trajectory 405 of denoising a data sample (e.g., from t=T to t=0). The resulting output (t=0) is a generated diffusion data point 400 representing an output from the diffusion model. Additional points of the trajectory 405 represent noised data points having at least some noise level (t>0). To generate an error for the consistency model, data samples at various noise levels are applied to the consistency model 420 to obtain corresponding denoised data points 430 representing the consistency model 420 applied to completely remove noise from the data points (e.g., to t=0). Each of the denoised data points 430 is then evaluated with a distance metric 440 with respect to the generated diffusion data point 400. The distance metric may be any suitable metric, such as a Euclidian distance, for measuring distances in the data domain of output data points. Using the respective distances between the denoised data points 430 and the generated diffusion data point 400, a consistency error 450 is generated describing the error of the consistency model 420. As one example, the consistency error 450 may be a sum of the distance metric for a plurality of the denoised data points 430. As such and as also shown in FIG. 3, the various noise levels of the trajectory are processed by the consistency model 420 to directly evaluate a loss with respect to the generated diffusion data point 400 generated by the diffusion model.

As such, a consistency error ε (e.g., which may be used for a training loss) for the consistency model may represent an expectation of a distance d for the output of an ODE solver of the diffusion model (ƒₛₒₗᵥₑᵣ) applied to points of the trajectory x_{T} at the corresponding nose level T compared with the output of the consistency model ƒ_{θ}(x_{T}, T) having parameters θ. Formally, this error may be given by Equation 4:

$$ε := {𝔼}_{{x}_{T} \sim {\hat{p}}_{T}} [ d ( {f}_{θ} ( {x}_{T} , T ) , {f}_{solver} ( {x}_{T} , T , 0 ) ) ] \qquad Equation 4$$

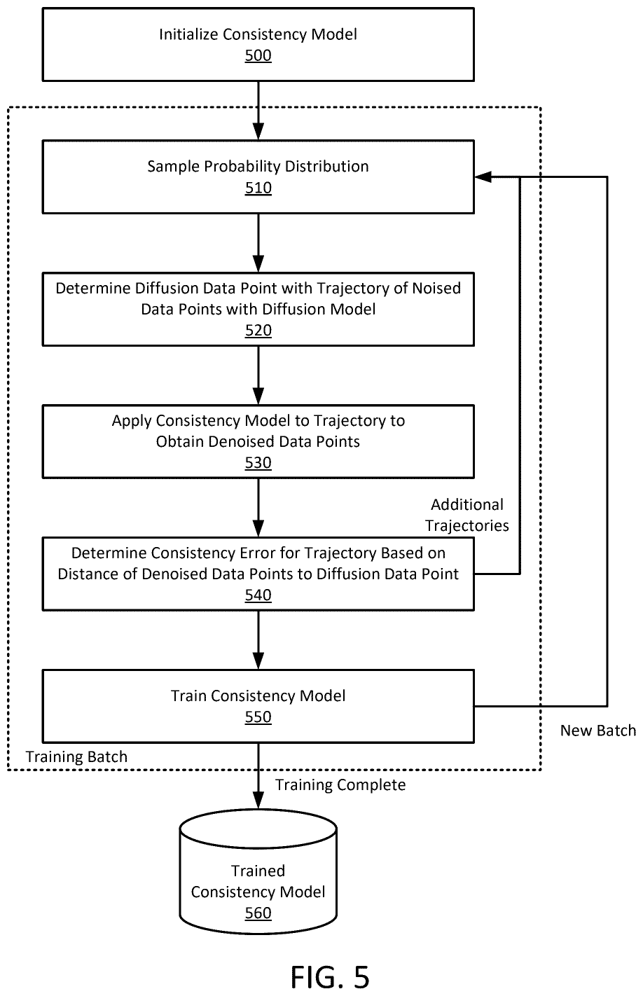

FIG. 5 shows an example process for training a consistency model, according to one or more embodiments. This process may be performed for training a consistency model using the system discussed in FIG. 1, for example with a model training module 120 as discussed above. Initially, a trained diffusion model is trained or obtained to be used as a “teacher” for distillation of the consistency model. Next, the consistency model may be initialized 500, for example, as a randomized set of parameters or, in some embodiments, using parameters of the diffusion model. In some embodiments, the consistency model and the diffusion model may have similar architectures, sharing a similar backbone and processing, such that the consistency model may be initialized 500 with the diffusion model's parameters.

Next, to obtain training data for the consistency model, data point trajectories are obtained for the diffusion model by sampling 510 from a corresponding probability distribution and applying the diffusion model to generate the trajectory and determine 520 the resulting diffusion data point (as an output at t=0) as discussed above.

Various noised data points of the trajectory may then be applied 530 with the consistency model to obtain corresponding denoised data points as discussed above. The denoised data points represent the attempt by the consistency model to directly obtain a denoised output, typically in a single call to the model. The denoised data points are then compared with the diffusion data point to determine respective distances for determining 540 a consistency error for this trajectory. Additional trajectories may also be generated with another sampling 510 from the probability distribution to obtain a plurality of trajectories and associated consistency errors to be used in a training batch of training the consistency model 550. The consistency model may be trained with any suitable training algorithm and may include backpropagation and other approaches for modifying the parameters of the consistency model according to the error of the consistency model applied to the training batch. After training the consistency model 550 to update its parameters, additional training batches may be generated with additional sampling from the probability distribution 510. When training is complete, the consistency model may be stored as a trained consistency model 560.

During inference, the trained consistency model 560 may then be used to generate data samples in fewer iterations than the diffusion model. Particularly, the consistency model may be configured to generate output data samples in one step, two steps, four steps, or other small quantities significantly smaller than the modeled “continuous” ODE of the diffusion model. Because the consistency model is trained to directly obtain a denoised output from any noise level based on the error as discussed above, a consistency model trained with this loss may better model the “solver” of the ODE applied to the diffusion model than consistency models using alternate loss functions.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system, comprising:
a processor that executes instructions; and
a non-transitory computer-readable medium having instructions executable by the processor for:
generating a diffusion data point with a diffusion model through a trajectory of noised data points from a sample of a probability distribution;
applying a consistency model to determine corresponding denoised data points for the trajectory of noised data points;
determining a consistency error of the consistency model with respect to the trajectory based on distance between the denoised data points and the diffusion data point; and
training parameters of the consistency model based on the consistency error.

2. The system of claim 1, wherein the diffusion model models a continuous differential equation.

3. The system of claim 1, wherein the instructions are further executable for initializing parameters of the consistency model with parameters of the diffusion model.

4. The system of claim 1, wherein the trajectory of noised data points comprise a plurality of data points having a corresponding plurality of noise levels.

5. The system of claim 1, wherein the instructions are further executable for generating a data point with another sample of the probability distribution applied to the consistency model.

6. The system of claim 5, wherein applying the consistency model comprises iteratively applying the consistency model fewer times than a number of times the consistency model is applied for the trajectory.

7. The system of claim 1, wherein the distance between the denoised data points and the diffusion data point is measured in an output domain.

8. A method, comprising:
generating a diffusion data point with a diffusion model through a trajectory of noised data points from a sample of a probability distribution;
applying a consistency model to determine corresponding denoised data points for the trajectory of noised data points;
determining a consistency error of the consistency model with respect to the trajectory based on distance between the denoised data points and the diffusion data point; and
training parameters of the consistency model based on the consistency error.

9. The method of claim 8, wherein the diffusion model models a continuous differential equation.

10. The method of claim 8, further comprising initializing parameters of the consistency model with parameters of the diffusion model.

11. The method of claim 8, wherein the trajectory of noised data points comprise a plurality of data points having a corresponding plurality of noise levels.

12. The method of claim 8, further comprising generating a data point with another sample of the probability distribution applied to the consistency model.

13. The method of claim 12, wherein applying the consistency model comprises iteratively applying the consistency model fewer times than a number of times the consistency model is applied for the trajectory.

14. The method of claim 8, wherein the distance between the denoised data points and the diffusion data point is measured in an output domain.

15. A non-transitory computer-readable medium, the non-transitory computer-readable medium comprising instructions executable by a processor for:
generating a diffusion data point with a diffusion model through a trajectory of noised data points from a sample of a probability distribution;
applying a consistency model to determine corresponding denoised data points for the trajectory of noised data points;
determining a consistency error of the consistency model with respect to the trajectory based on distance between the denoised data points and the diffusion data point; and
training parameters of the consistency model based on the consistency error.

16. The non-transitory computer-readable medium of claim 15, wherein the diffusion model models a continuous differential equation.

17. The non-transitory computer-readable medium of claim 15, wherein the instructions are further executable for initializing parameters of the consistency model with parameters of the diffusion model.

18. The non-transitory computer-readable medium of claim 15, wherein the trajectory of noised data points comprise a plurality of data points having a corresponding plurality of noise levels.

19. The non-transitory computer-readable medium of claim 15, wherein the instructions are further executable for generating a data point with another sample of the probability distribution applied to the consistency model.

20. The non-transitory computer-readable medium of claim 19, wherein applying the consistency model comprises iteratively applying the consistency model fewer times than a number of times the consistency model is applied for the trajectory.
